(19) United States
(12) Patent Application Publication
(10) Pub. No.: US 2012/0033082 A1
(43) Pub. Date: Feb. 9, 2012

(54) System and Method for Spatial Division Multiplexing Detection

(75) Inventor: Yei Wo, East Brunswick, NJ (US)

(73) Assignee: D & S CONSULTANTS, INC., Eatontown, NJ (US)

(21) Appl. No.: 12/851,630

(22) Filed: Aug. 6, 2010

(51) Int. Cl. H04N 7/18; G01T 1/00; G01J 1/42; H05G 1/64

(52) U.S. Cl. 348/159; 378/1; 250/336.1; 250/372; 348/E07.085

(57) ABSTRACT

A system and method for detecting and monitoring one or more targets uses surveillance monitors that are selectively aligned in pre-determined directions to form an integrated field of view (IFOV). The IFOV or portions thereof may be illuminated using a scanning laser beam. Information provided by the surveillance monitors is selectively processed in an order determined based on a pre-determined target search and monitoring algorithm. Embodiments are directed to increasing efficiency of detecting or monitoring targets and, in particular, multiple moving targets.

### FIELD OF THE INVENTION

The present inventions generally relates to the field of electronic surveillance and, in particular, to a system and method for detecting and monitoring one or more targets.

### BACKGROUND OF THE INVENTION

Electronic surveillance is extensively used by military, law enforcement, commercial, and private entities. Typically, the goals of electronic surveillance include detection and monitoring of one or more objects of interest (referred to herein as “targets”) in video data sequences produced by respective surveillance apparatus(es). In applications, electronic surveillance is often performed in a real time.

Main challenges in the field of electronic surveillance relate to detection of targets that change their characteristics due to motion, orientation in 3D space, or temporary occlusion by other objects. FIG. 1 depicts a high-level, schematic diagram of a conventional system 100 for detecting and monitoring targets. The system 100 includes a low-resolution stationary video camera 110 having a large field of view 102 and a high-resolution video camera 120 having a small field of view 106.

Video camera 120 is typically mounted on a gimbaled platform 104, which provides panning the field of view of the high resolution camera 106 within the field of view of the lower resolution camera 102 (illustratively shown with arrows 108). However, in operation, insufficient resolution of camera 110 and a limited size and speed of panning the field of view of the high resolution camera 106 to acquire targets of interest detrimentally affect efficiency of the system 100.

Therefore, despite the considerable effort in the art devoted to systems and methods for detecting and monitoring targets, further improvements would be desirable.

### SUMMARY OF THE INVENTION

Embodiments of the present invention are generally directed to systems and methods for detecting and monitoring targets, including multiple moving targets.

One aspect of the invention provides a system for detecting and monitoring targets. The system comprises a plurality of surveillance monitors, which are selectively aligned in pre-determined directions to form an integrated field of view of the system. The integrated field of view is substantially equal to a sum of the fields of view of the component surveillance monitors and may represent, for example, an M×N matrix of the fields of view of these monitors, where M and N are integers and at least one M or N is greater than 1. To increase detectability of the targets, at least portions of the integrated field of view may be illuminated using a scanning laser beam.

Another aspect of the present invention provides a method for detecting and monitoring targets using the inventive system.

Various other aspects and embodiments of the invention are described in further detail below.

This summary is neither intended nor should it be construed as being representative of the full extent and scope of the present invention, which these and additional aspects will become more readily apparent from the detailed description, particularly when taken together with the appended drawings.

### BRIEF DESCRIPTION OF THE DRAWINGS

FIG. 1 is a high-level, schematic diagram of a conventional system of the prior art for detecting and monitoring targets.

FIG. 2 is a high-level, schematic diagram of an exemplary system for detecting and monitoring targets in accordance with one embodiment of the present invention.

FIG. 3 is a flow diagram of a method for detecting and monitoring targets using the system of FIG. 2 in accordance with one embodiment of the present invention.

To facilitate understanding, identical reference numerals have been used, where possible, to designate identical elements that are common to the figures. The images in the drawings are simplified for illustrative purposes and are not depicted to scale.

The figures of this application illustrate exemplary embodiments of the invention and, as such, should not be considered as limiting the scope of the invention that may admit to other equally effective embodiments. It is contemplated that features or steps of one embodiment may beneficially be incorporated in other embodiments without further recitation.

### DETAILED DESCRIPTION

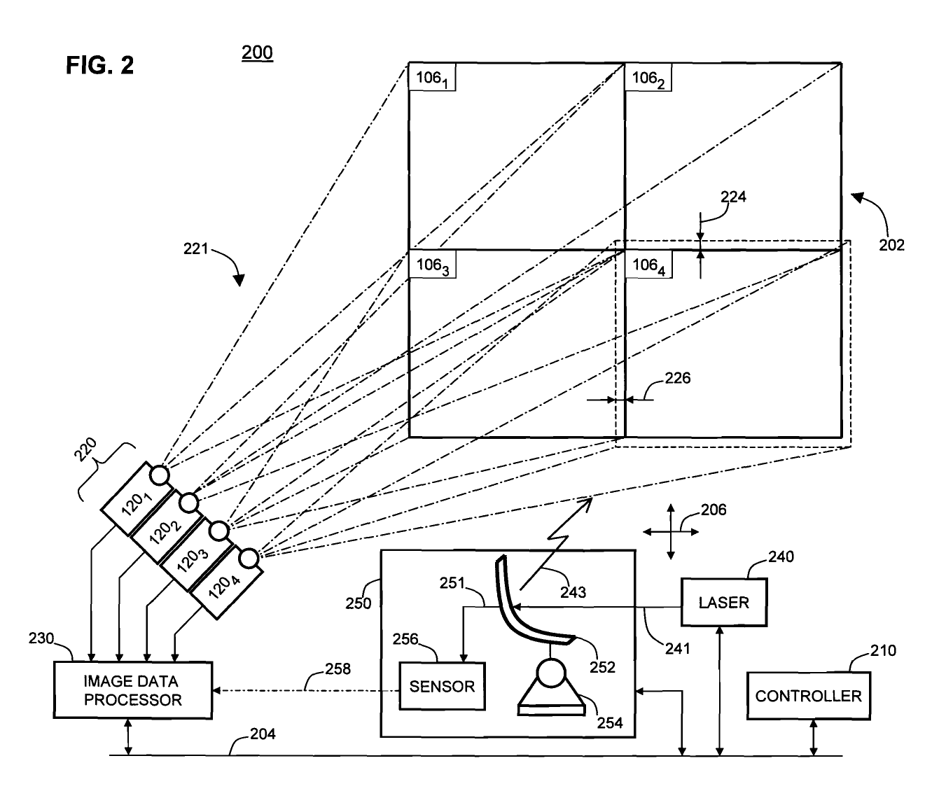

Referring to the figures, FIG. 2 depicts a high-level, schematic diagram of an exemplary system 200 for detecting and monitoring targets in accordance with one embodiment of the present invention

Hereafter, aspects of the present invention are illustratively described within the context of targets. A target in this context can be any stationary or moving object, such as land vehicles, aircraft, missiles or their plumes (for example, rocket propelled grenades (RPGs), ballistic or cruise missiles, among other missiles), traces of laser beams, objects floating in air, free space, liquid or on a surface of liquid, and the like. The invention may also be utilized within the context of other types of targets (for example, humans, animals, or body parts thereof or various material objects), which presence and/or movements are monitored in the respective conventional habitats, conditions, or environment. It has been contemplated and is within the scope of the invention that the system 200 is utilized within the context of any of such targets or a combination thereof.

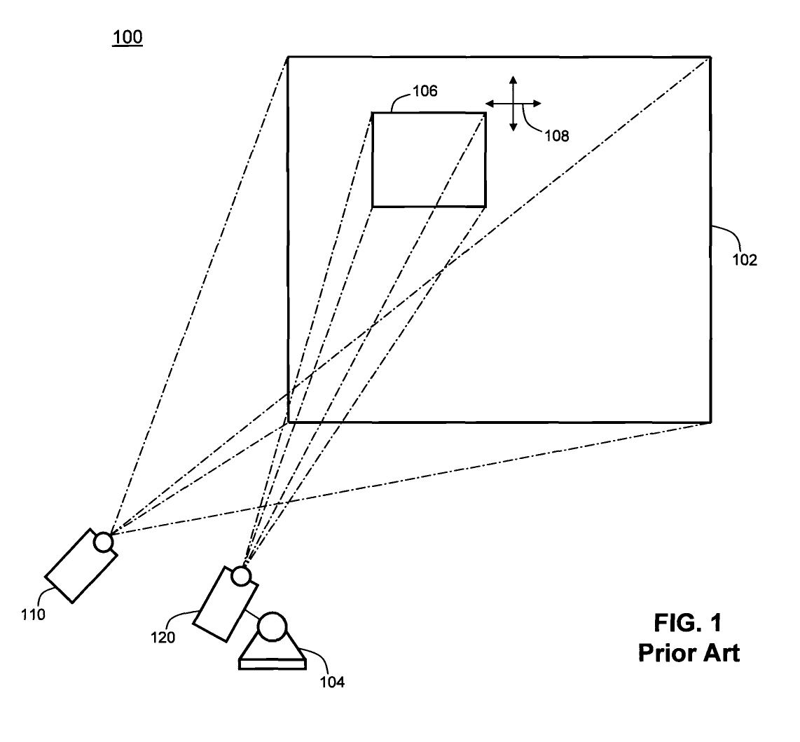

In one exemplary embodiment, the system 200 includes a controller 210, a plurality 220 of stationary surveillance monitors 120₁-120ₙ (surveillance monitors 120₁-120₄ are shown), an image data processor 230, and, optionally, a laser 240 and a laser beam scanning apparatus 250. In a preferred embodiment, stationary surveillance monitors 120₁-120ₙ are high resolution video cameras of the type shown in the prior art system of FIG. 1.

In operation, the controller 210 administers the functioning of components of the system 200 and implements a pre-determined target search/monitoring algorithm, which may be implemented by software or firmware stored in a memory of controller 210 or, alternatively, in a memory of image data processor 230.

Controller 210 is generally an industrial or military specification computer processor adapted to control various computational and hardware resources. In the depicted embodiment, the controller 210 is coupled to the components of the system 200 via a common bus 204.

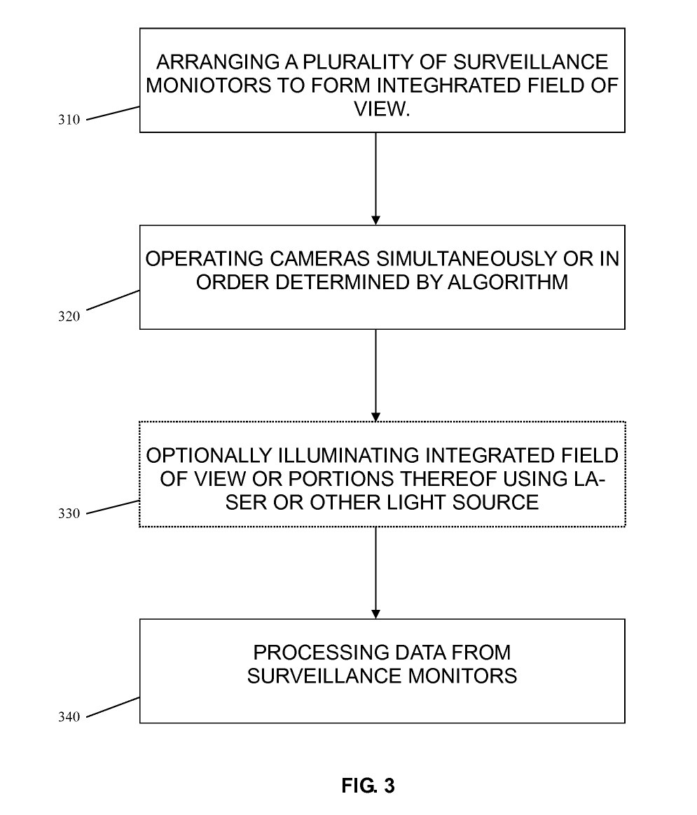

Surveillance monitors 120₁-120ₙ are generally sensors of particular targets or their respective identifiers, for example, digital video cameras, telescopes, detectors of visible, infra-red (IR) or ultra-violet (UV) light, X-rays or ionizing radiation, among other sensors. Information acquired by monitors 120₁-120ₙ is processed by image data processor 230, as discussed below in reference to FIG. 3.

Surveillance monitors 120₁-120ₙ may be installed on either stationary or moving platforms, including ground, buildings, planes or helicopters, ships, balloons, unmanned aerial vehicles (UAVs), and the like, but in general are stationary with respect to each other. That is, unlike the prior art system shown in FIG. 1, surveillance monitors 120₁-120ₙ are not gimbaled, such as to be able to move with respect to each other or with respect to the stationary or moving platform upon which system 200 of the present invention is mounted, but are stationary, such as to define integrated field of view (IFOV) 202. In one exemplary embodiment, the surveillance monitors 120₁-120ₙ are ground-mounted, high resolution digital video cameras.

The surveillance monitors 120 are selectively aligned and fixed in pre-determined directions in three dimensional space in a manner providing that, in the space, their respective fields of view, or apertures, form a pre-determined pattern. Although FIG. 2. shows a two dimensional pattern formed by aligning fields of view 106₁-106ₙ of surveillance monitors 120₁-120ₙ respectively, other arrangements may be used, such as forming a three dimensional IFOV by aligning the fields of view 106₁-106ₙ of surveillance monitors 120₁-120ₙ to the same area of space, but setting different depths of field on each individual monitor. In another embodiment, the fields of view 106₁-106ₙ of surveillance monitors 120₁-120ₙ may be disjoint.

A sum of the fields of view of the fixed surveillance monitors 120₁-120ₙ represents integrated field of view 202 of the system 200. In system 200, the surveillance monitors 120₁-120ₙ are high-resolution sensors that are operated simultaneously. As such, target resolution capabilities of a single surveillance monitor 120 are instantly provided over the entire IFOV of the system.

Typically, the surveillance monitors 120₁-120ₙ have the same or substantially the same resolution and apertures, and the system 200 preferably comprises from about two to nine surveillance monitors, although any number may be used to form the IFOV, and, the cameras may differ in field of view and aperture. Preferably, the IFOV is contiguous. In one embodiment, the IFOV of the system 200 is an M×N matrix of the fields forming a rectangular or quadrate IFOV, wherein M and N are integers and at least one M or N is greater than 1.

For example, in the embodiment depicted in FIG. 2, fields of view 106₁-106₄ of the surveillance monitors 120₁-120₄ form a 2×2 matrix representing an IFOV 202 of the system 200 (boundaries of the apertures of the surveillance monitors 120₁-120₄ are shown with phantom lines 221). In some embodiments, the IFOV 202 and the field of view 102 (discussed in reference to FIG. 1) may have the same or similar dimensions.

In 3D space, adjacent fields of view preferably overlap one another by pre-determined margins 224 and 226 (shown with broken lines for the field of view 106₄ only) and any overlap is taken into account by software in image data processor 230. Generally, the margins 224 and 226 are selected in a range from 5 to 20% of the respective width of the field of view.

In the system 200, a number K of the surveillance monitors is generally defined by areas of the required IFOV and the fields of view of component surveillance monitors 120, and an amount of overhead A_{OV} caused by overlapping of the adjacent fields of view. In particular, if an area of a field of view of a component surveillance monitor 120 is equal to A_{SM}, the system 200 having a rectangular IFOV with an area S may comprise K=S/(A_{SM}+A_{OV}) surveillance monitors 120.

Optionally, a laser may be provided as a component of the system. Laser 240 irradiates a beam 241 adapted to illuminate the one or more targets to increase their detectability by the surveillance monitors 120. Targets may be selected by the target search/monitoring software, running on either controller 210 or image data processor 230. In operation, the laser beam scanning apparatus 250 scans (illustrated using arrows 206) the beam 241 in the IFOV of the system 200 (e.g., IFOV 202) or portions thereof, as discussed below in reference to FIG. 3.

Laser beam scanning apparatus 250 generally comprises a substantially reflective concave minor 252 disposed on a gimbaled platform 254 and a sensor 256. In operation, the gimbaled platform 254 engages the minor 252 in a cyclical motion, which results in scanning of the laser beam 243 reflected from the minor 252 in the entire IFOV or a pre-determined portion of the IFOV, as determined by the target search/monitoring software.

In one embodiment, the mirror 252 has a calibrated value of a leak of incident laser radiation (i.e., beam 241) through the material of the minor, and a leaked portion 251 of the beam 241 is acquired by the sensor 256. Orientation of the laser beam 243 in the space and spatial characteristics of the leaked portion 251 are inter-related and are defined by an instant position of the minor 252.

Sensor 256 (for example, a charged-coupled device (CCD) sensor) analyzes the portion 251 of the beam 241 to determine the direction, in the 3D space, of the reflected laser beam 243. In particular, the sensor 256 identifies the surveillance monitor 120, which field of view or a portion thereof is currently illuminated by the laser beam 243, and provides this information to the image data processor 230 (shown in phantom with a link 258).

FIG. 3 is a flow diagram of a method 300 for detecting and monitoring targets using the system 200 of FIG. 2 in accordance with one embodiment of the present invention. To best understand the invention, the reader should refer to FIGS. 2-3 simultaneously.

The method 300 is illustratively discussed herein in reference to the system 200 having four surveillance monitors 120₁-120₄. In other embodiments, the system 200 may comprise a different number of the surveillance monitors or surveillance monitors aligned to form an IFOV having a different form factor.

In various embodiments, method steps of the method 300 are performed in the depicted order or at least two of these steps or portions thereof may be performed contemporaneously, in parallel, or in a different order. For example, portions of steps 330 and 340 may be performed contemporaneously or in parallel. Those skilled in the art will readily appreciate that the order of executing at least a portion of other discussed below processes or routines may also be modified.

At step 310, a plurality of surveillance monitors (for example, surveillance monitors 120₁-120₄) are aligned in pre-determined directions to form, in 3D space, an IFOV having a pre-selected form factor (for example, IFOV 202 having a 2×2 quadrate form factor).

At step 320, the surveillance monitors of system 200 are simultaneously engaged (i.e., activated), thereby forming the IFOV of system 200. Within the IFOV, a plurality of targets may be detected and/or monitored using target search/monitoring software, with the high resolution of the component surveillance monitors (i.e., surveillance monitors 120₁-120₄).

At step 330, the IFOV or one or more pre-determined fields of view of particular surveillance monitors may optionally be scanned by a beam of a laser (for example, laser 240) that is adapted to illuminate at least portions of the IFOV, preferably portions of IFOV containing the target(s) and, as such, increase detectability of the target(s). In one embodiment, the laser beam may continuously scan the entire IFOV of the system 200. In alternate embodiments, after particular targets have been detected, the laser beam may selectively illuminate these targets.

At step 340, information provided by the surveillance monitors is processed by a respective data processor (e.g., image data processor 230). In one embodiment, the data processor processes information provided by each of the surveillance monitors in an order that is determined based on a target search/monitoring algorithm. For example, information provided by each of the surveillance monitors may be processed sequentially.

In an alternate embodiment, when a specific target is expected to be present in the field of view of a particular surveillance monitor, information provided by that monitor may be processed more frequently. Optionally, laser beam 243 may scan the field of view of that surveillance monitor more frequently or with a smaller pitch. In yet another embodiment, a combination of these or other search/monitoring algorithms may be used in system 200.

Although the invention herein has been described with reference to particular illustrative embodiments, it is to be understood that these embodiments are merely illustrative of the principles and applications of the present invention. Therefore numerous modifications may be made to the illustrative embodiments and other arrangements may be devised without departing from the spirit and scope of the present invention, which is defined by the appended claims.

What is claimed is:

1. A system for detecting or monitoring one or more targets comprising:
a plurality of surveillance monitors, each surveillance monitor selectively aligned in a pre-determined direction; and
a processor running software for the processing of information provided by said surveillance monitors;
wherein the fields of view of said surveillance monitors form an integrated field of view that is substantially equal to a sum of the fields of view of said surveillance monitors.

2. The system of claim 1 wherein the fields of view of said surveillance monitors are aligned such as to form a contiguous integrated field of view.

3. The system of claim 2 wherein the adjacent fields of view of said surveillance monitors overlap one another by pre-determined margins.

4. The system of claim 1 wherein said surveillance monitors are operated simultaneously.

5. The system of claim 1 wherein the data processor is adapted to process the information in an order defined based on a pre-determined target search and monitoring algorithm of said system.

6. The system of claim 1 further comprising:
a laser adapted to illuminate one or more targets; and
an apparatus adapted to scan a beam of the laser in at least a portion of said integrated field of view.

7. The system of claim 6 wherein:
said apparatus is adapted to scan said laser in a region of said integrated field of view designated by a targeting algorithm implemented in said software running on said processor;
wherein said software is adapted to selectively process information provided by the surveillance monitor having the field of view containing the target.

8. The system of claim 7 further comprising:
a sensor adapted to identify a surveillance monitor having a field of view being scanned by said laser beam.

9. The system of claim 8 wherein:
said apparatus comprises a substantially reflective mirror having a calibrated leak of laser radiation through material of the minor; and
said sensor is adapted to identify the surveillance monitor based on analysis of the leaked laser radiation.

10. The system of claim 1 wherein said surveillance monitors are selected from the group consisting of video recording devices, telescopes, detectors of visible, infra-red (IR), or ultra-violet (UV) light, and detectors of X-rays or ionizing radiation.

11. The system of claim 10 wherein said video recording devices are digital video cameras.

12. A method for detecting or monitoring one or more targets comprising the steps of:
(a) selectively aligning the fields of view of a plurality of surveillance monitors such as to form an integrated field of view substantially equal to a sum of fields of view of said surveillance monitors;
(b) operating said surveillance monitors; and
(c) processing information provided by the surveillance monitors.

13. The method of claim 12 wherein said surveillance monitors are selected from a group consisting of video recording devices, telescopes, detectors of visible, infra-red (IR), or ultra-violet (UV) light, and detectors of X-rays or ionizing radiation.

14. The method of claim 13 wherein said video recording devices are digital video cameras.

15. The method of claim 12 wherein the adjacent fields of view of said surveillance monitors overlap by pre-determined margins.

16. The method of claim 12 wherein step (a) further comprises the step of:
aligning the fields of view of said surveillance monitors such as to form a contiguous integrated field of view

17. The method of claim 12 wherein step (c) further comprises the step of:
processing the information in an order determined based on a target search and monitoring algorithm.

18. The method of claim 12, wherein step (b) further comprises the step of:
scanning at least a portion of the integrated field of view with a laser adapted to illuminate one or more targets identified by said target search and monitoring algorithm.

19. The method of claim 18 further comprising the steps of:
scanning said laser in a region defined based on said target search and monitoring algorithm; and
selectively processing information provided by the surveillance monitor having a field of view containing the target.

20. The method of claim 20 further comprising the step of:
scanning said laser using a substantially reflective minor having a calibrated leak of laser radiation through material of the minor.

21. The method of claim 20 further comprising the step of
identifying a surveillance monitor having a field of view being scanned by said laser based on analysis of the leaked laser radiation.

22. A system using the method of claim 12.

23. A method for detecting or monitoring one or more targets comprising the steps of:
defining boundaries of a controlled region;
identifying in the controlled region a plurality of controlled sub-regions; and
monitoring the controlled region using surveillance monitors each having a field of view substantially equal to a controlled sub-region, each of said surveillance monitors being selectively aligned in a pre-determined direction to define one of said controlled sub-regions.

24. The method of claim 23 further comprising the step of:
aligning fields of view of said surveillance monitors to form a contiguous integrated field of view.

25. The method of claim 23 further comprising the step of:
operating the surveillance monitors simultaneously.

26. The method of claim 26 further comprising the step of:
processing data provided by the surveillance monitors in an order defined by a target search and monitoring algorithm.

27. The method of claim 23 further comprising the steps of:
scanning at least a portion of said controlled region using a laser adapted to illuminate the one or more targets;
identifying a surveillance monitor having a field of view being scanned by said laser; and
selectively processing information provided by said identified surveillance monitor.

28. The method of claim 23 wherein said surveillance monitors are selected from a group consisting of video recording devices, telescopes, detectors of visible, infra-red (IR), or ultra-violet (UV) light, and detectors of X-rays or ionizing radiation.

29. A system using the method of claim 23.

30. The method of claim 17 wherein said target search and monitoring algorithm is implemented as software stored on a computer readable medium.
